(19) United States
(12) Patent Application Publication
(10) Pub. No.: US 2025/0254741 A1
(43) Pub. Date: Aug. 7, 2025

(54) U2U RELAY DISCOVERY AND (RE-)SELECTION

(71) Applicant: Fraunhofer-Gesellschaft zur Förderung der angewandten Forschung e.V., München (DE)

(72) Inventors: Julian POPP, Erlangen (DE); Mehdi HAROUNABADI, Erlangen (DE); Elke ROTH-MANDUTZ, Erlangen (DE); Negar HAJIJALILI, Erlangen (DE); Gustavo Wagner OLIVEIRA DA COSTA, Erlangen (DE)

(73) Assignee: Fraunhofer-Gesellschaft zur Förderung der angewandten Forschung e.V., München (DE)

(21) Appl. No.: 19/048,916

(22) Filed: Feb. 8, 2025

Related U.S. Application Data
(63) Continuation of application No. PCT/EP2023/071807, filed on Aug. 7, 2023.

(30) Foreign Application Priority Data
Aug. 8, 2022 (EP) 22189342.3

(51) Int. Cl. H04W 76/14; H04W 8/00; H04W 36/00; H04W 36/30; H04W 88/04; H04W 92/18

(52) U.S. Cl. CPC H04W 76/14; H04W 8/005; H04W 36/035; H04W 36/302; H04W 88/04; H04W 92/18

(57) ABSTRACT

Embodiments provide a UE [e.g., source UE] of a wireless [e.g., radio based] communication system [e.g., 5G/NR communication system], wherein the UE is configured to operate in a sidelink mode of operation [e.g., 5G/NR sidelink mode 1 or mode 2], wherein the UE is configured, for establishing a connection with a target UE or a group of target UEs [e.g., the group of target UEs having a group ID] via a UE-to-UE relay, to transmit [e.g., via the sidelink] a discovery message for discovering one or more candidate relay UEs that are connected or able to connect [e.g., via the sidelink] to the target UE or group of target UEs.

### CROSS-REFERENCE TO RELATED APPLICATIONS

This application is a continuation of copending International Application No. PCT/EP2023/071807, filed Aug. 7, 2023, which is incorporated herein by reference in its entirety, and additionally claims priority from European Application No. EP 22189342.3, filed Aug. 8, 2022, which is also incorporated herein by reference in its entirety.

Embodiments of the present application relate to the field of wireless communication, and more specifically, to wireless communication between two UEs (e.g., source UE and a target UE) via a UE-to-UE relay. Some embodiments relate to U2U relay discovery and selection.

### BACKGROUND OF THE INVENTION

FIG. 1A is a schematic representation of an example of a terrestrial wireless network 100 including a core network 102 and one or more radio access networks RAN1, RAN2, . . . RANN. FIG. 1B is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANn may include more or less such cells, and RANn may also include only one base station. FIG. 1B shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1B shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1B by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1B by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1A and FIG. 1B may by a heterogeneous network having distinct overlaid networks, e.g., a network of macro cells with each macro cell including a macro base station, like base station gNB1 to gNB5, and a network of small cell base stations (not shown in FIG. 1A and FIG. 1B), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1A and FIG. 1B, for example in accordance with the LTE-Advanced Pro standard or the NR (5G), new radio, standard.

In mobile communication networks, for example in a network like that described above with reference to FIG. 1A and FIG. 1B, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1B. This is referred to as an “in-coverage” scenario. Another scenario is referred to as an “out-of-coverage” scenario. It is noted that “out-of-coverage” does not mean that the two UEs are not within one of the cells depicted in FIG. 1B, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1B. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1B. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system as described above, in a UE-to-Network relay, the target/destination for the remote UE is clear—it is the network. In UE-to-UE relay the target UE can be connected to any relay UE. For UE-to-UE relaying there arises the issue of how to find the correct relay UE that has the target/destination UE connected to it.

Therefore, there is the need for improvements with respect to UE-to-UE relaying.

It is noted that the information in the above section is only for enhancing the understanding of the background of the invention and therefore it may contain information that does not form conventional technology and is already known to a person of ordinary skill in the art.

### SUMMARY

An embodiment may have a UE of a wireless communication system, wherein the UE is configured to operate in a sidelink mode of operation, wherein the UE is configured, for establishing a connection with a target UE or a group of target UEs via a UE-to-UE relay, to transmit a discovery message for discovering one or more candidate relay UEs that are connected or able to connect to the target UE or group of target UEs.

Another embodiment may have a relay UE of a wireless communication system, wherein the relay UE is configured to operate in a sidelink mode of operation, wherein the relay UE is configured to receive a discovery message from a source UE, the discovery message indicating a target UE or a group of target UEs to which the source UE requests a relaying of messages, wherein the relay UE is configured, in case the relay UE is able to relay messages between the source UE and the target UE or group of target UEs, to transmit a discovery message response to the source UE, the discovery message response indicating that the relay UE is able to relay messages between the source UE and the target UE or group of target UEs.

Another embodiment may have target UE of a wireless communication system, wherein the target UE is configured to operate in a sidelink mode of operation, wherein the target UE is configured to communicate with a source UE of the wireless communication network via a relay UE of the wireless communication network, wherein the target UE is configured to reselect another relay UE or to transmit a relay reselection control message to the source UE, the relay reselection control message controlling the source UE and/or the base station to select another relaying UE when a reselection criterion is fulfilled.

According to another embodiment, a wireless communication system may have: an inventive source UE, an inventive relay UE, and an inventive target UE.

According to another embodiment, a method for operating a UE of a wireless communication system may have the steps of: operating the UE in a sidelink mode of operation, transmitting, for establishing a connection with a target UE or a group of target UEs via a UE-to-UE relay, a discovery message for discovering one or more candidate relay UEs that are connected or able to connect to the target UE or group of target UEs.

According to another embodiment, a method for operating a relay UE of a wireless communication system may have the steps of: operating the relay UE in a sidelink mode of operation, receiving a discovery message from a source UE, the discovery message indicating a target UE or a group of target UEs to which the source UE requests a relaying of messages, transmitting, in case the relay UE is able to relay messages between the source UE and the target UE or group of target UEs, a discovery message response to the source UE, the discovery message response indicating that the relay UE is able to relay messages between the source UE and the target UE or group of target UEs.

According to another embodiment, a method for operating a target UE of a wireless communication system may have the steps of: operating the target UE in a sidelink mode of operation, communicating with a source UE of the wireless communication network via a relay UE of the wireless communication network, reselecting another relay UE or transmitting a relay reselection control message to the source UE, the relay reselection control message controlling the source UE to select another relaying UE, when a reselection criterion is fulfilled.

Another embodiment may have a computer program for performing any one of the inventive methods when the computer program runs on a computer, microprocessor or software defined radio.

### BRIEF DESCRIPTION OF THE DRAWINGS

Embodiments of the present invention will be detailed subsequently referring to the appended drawings, in which:

FIG. 1A shows a schematic representation of an example of a wireless communication system;

FIG. 1B is a schematic representation of an example of a radio access network;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication network;

FIG. 7 is a schematic representation of End-to-End User Plane protocol stacks using a Layer-2 UE-to-UE Relay [1];

FIG. 8 is a schematic representation of End-to-End Control Plane protocol stacks using a Layer-2 UE-to-UE Relay [1];

FIG. 9 is a schematic representation of three different scenarios of discovering the target UE via a relay UE;

FIG. 10 is a schematic representation of a wireless communication system comprising a transceiver, like a base station or a relay, and a plurality of communication devices, like UEs, according to an embodiment;

FIG. 11 is a schematic representation of wireless communication system, where source UE, relay UE and destination UE are in-coverage [2];

FIG. 12 is a schematic representation of wireless communication system, where source UE, relay UE and destination UE are out-of-coverage [2];

FIG. 13 is a schematic representation of wireless communication system, where at least one of the UEs involved in relaying (e.g., source UE, relay UE, destination UE) is in-coverage, and at least one of the UEs involved in relaying is out-of-coverage (partial coverage) [2];

FIG. 14 is a schematic representation of a wireless communication system comprising in-coverage and out-of-coverage UEs;

FIG. 15 is a schematic representation of a wireless communication system comprising in-coverage and out-of-coverage UEs;

FIG. 16 is a schematic representation of a U2U relay scenario;

FIG. 17 is a schematic representation of a source UE initiating discovery procedure; and

FIG. 18 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As already indicated in the introductory portion, in a UE-to-Network relay, the target/destination for the remote UE is clear—it is the network. In UE-to-UE relay the target UE can be connected to any relay UE. For UE-to-UE relaying there arises the issue of how to find the correct relay UE that has the target/destination UE connected to it.

Unlike U2N relay scenarios, the discovery of a third, potentially unknown, target UE is more challenging, especially in out-of-coverage scenarios. The remote UE does not know, which other remote UEs are reachable via a relay UE and has to ‘discover’ this first, if the source UE did not have a connection to the target UE before. The relay UE on the other hand, only knows the UEs that it has already discovered or that have an existing connection with the relay UE.

The already existing solution is a relayed discovery message by the relay UE, a response of the target remote UE and a reply by the relay UE to the source remote UE.

This approach introduces additional delay into the communication part, because of two needed PC5 message flows. On the other hand, if the target remote UE is discoverable by the source remote UE, there is no change in the protocol needed.

If the remote source UE only receives an answer from the relay UE, the path to the target remote UE is obvious. If more relay UEs reply, a selection of one relay is needed. The criteria on how to select the appropriate one are unclear/not specified.

Before embodiments of the present invention are described in full detail in section 2, first in section 1 background for sidelink relaying is provided.

### 1. Background

Depending on the SL mode (in-coverage or out-of-coverage) the UE has to take decisions on its own or can be guided by the gNodeB. For in-coverage scenarios, the gNodeB allocates resources and knows about relay UEs in the cell. A source UE can ask for relay information and/or allocation of a relay. The current specifications are defining U2N relay only.

In TR 38.836 the basic procedure for U2U relay discovery is based on TS 23.303.

### 1.1 PC5 Basic Information

Subsequently, basic information that might be useful to understand the context is described based on [4].

Two sidelink resource allocation modes are supported: mode 1 and mode 2.

In mode 1, the sidelink resource allocation is provided by the network.

In mode 2, UE decides the SL transmission resources in the resource pool(s).

Physical Sidelink Control Channel (PSCCH) indicates resource and other transmission parameters used by a UE for PSSCH. PSCCH transmission is associated with a DM-RS.

Physical Sidelink Shared Channel (PSSCH) transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

Physical Sidelink Feedback Channel (PSFCH) carries HARQ feedback over the sidelink from a UE which is an intended recipient of a PSSCH transmission to the UE which performed the transmission. PSFCH sequence is transmitted in one PRB repeated over two OFDM symbols near the end of the sidelink resource in a slot.

The Sidelink synchronization signal consists of sidelink primary and sidelink secondary synchronization signals (S-PSS, S-SSS), each occupying 2 symbols and 127 subcarriers. Physical Sidelink Broadcast Channel (PSBCH) occupies 9 and 5 symbols for normal and extended CP cases respectively, including the associated DM-RS.

For unicast, channel state information reference signal (CSI-RS) is supported for CSI measurement and reporting in sidelink. A CSI report is carried in a sidelink MAC CE.

Logical channels are classified into two groups: Control Channels and Traffic Channels. Control channels are used for the transfer of control plane information only.

Common Control Channel (CCCH) is a channel for transmitting control information between UEs and network. This channel is used for UEs having no RRC connection with the network [4].

The following identities are used for NR sidelink communication:
Source Layer-2 ID: Identifies the sender of the data in NR sidelink communication. The Source Layer-2 ID is 24 bits long and is split in the MAC layer into two bit strings:
   One bit string is the LSB part (8 bits) of Source Layer-2 ID and forwarded to physical layer of the sender. This identifies the source of the intended data in sidelink control information and is used for filtering of packets at the physical layer of the receiver;
   Second bit string is the MSB part (16 bits) of the Source Layer-2 ID and is carried within the MAC header. This is used for filtering of packets at the MAC layer of the receiver.
Destination Layer-2 ID: Identifies the target of the data in NR sidelink communication. For NR sidelink communication, the Destination Layer-2 ID is 24 bits long and is split in the MAC layer into two bit strings:
   One bit string is the LSB part (16 bits) of Destination Layer-2 ID and forwarded to physical layer of the sender. This identifies the target of the intended data in sidelink control information and is used for filtering of packets at the physical layer of the receiver;
   Second bit string is the MSB part (8 bits) of the Destination Layer-2 ID and is carried within the MAC header. This is used for filtering of packets at the MAC layer of the receiver.
PC5 Link Identifier: Uniquely identifies the PC5 unicast link in a UE for the lifetime of the PC5 unicast link as specified in [5]. The PC5 Link Identifier is used to indicate to upper layers the PC5 unicast link in which sidelink RLF was declared and corresponding PC5-RRC connection was released.

### 1.2 General Sidelink Description

NR sidelink communication can support one of three types of transmission modes for a pair of a Source Layer-2 ID and a Destination Layer-2 ID in the AS:
Unicast transmission, characterized by:
   Support of one PC5-RRC connection between peer UEs for the pair;
   Transmission and reception of control information and user traffic between peer UEs in sidelink;
   Support of sidelink HARQ feedback;
   Support of sidelink transmit power control;
   Support of RLC AM;
   Detection of radio link failure for the PC5-RRC connection.
Groupcast transmission, characterized by:
   Transmission and reception of user traffic among UEs belonging to a group in sidelink;
   Support of sidelink HARQ feedback.
Broadcast transmission, characterized by:
   Transmission and reception of user traffic among UEs in sidelink.

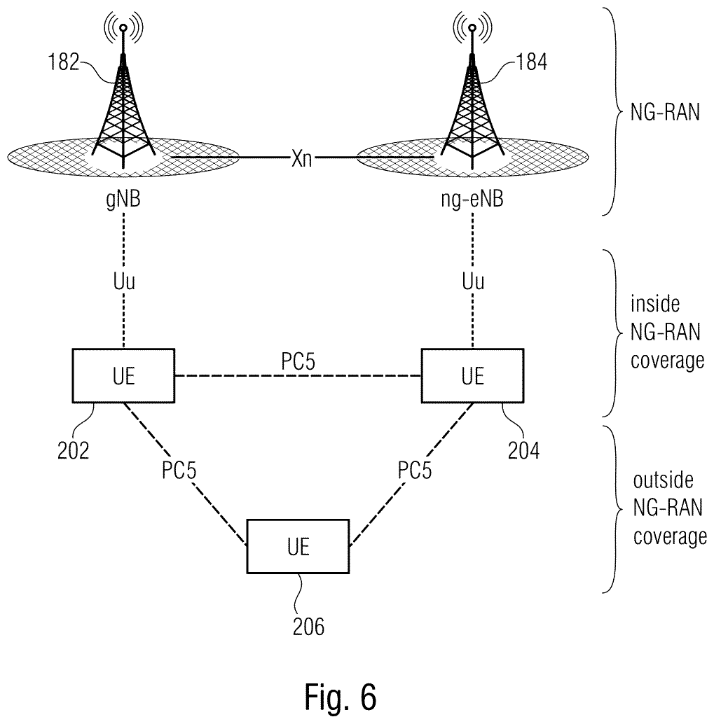

FIG. 6 is a schematic representation of a wireless communication network. For way of example, in FIG. 6 two base stations 182 and 180 are shown that are communicating via the Xn interface. The two base stations 182 and 184 form a new generation radio access network, NG-RAN. Thereby, it is exemplarily assumed that the first base station 182 is a gNode B (gNB), where the second base station 184 is a new generation evolved Node B (ng-eNB). Further, in FIG. 6 three UEs 202, 204 and 206 are shown, wherein UEs 202 and 204 are in-coverage of the base stations 182 and 184 (e.g., inside NG-RAN coverage), where UE 206 is out-of-coverage (e.g., outside NG-RAN coverage). Each of the UEs 202 and 204 is communicating with the respective base station via the Uu interface, wherein the UEs 202, 204 and 206 are directly communicating with each other via the PC5 interface.

### 1.3 U2N Discovery Procedure [1]

ProSe Direct Discovery consists of two components (see [1] clause 6.2.2.2, which is based on [5], clause 6.3.3).

A first component is listening. This procedure consists of the UE listening for broadcast data. Depending on the ProSe Application ID that the UE is wanting to use, the UE may be needed to listen for one or more (e.g., any or all) of the following:
1. Destination Layer 2-ID;
1. ProSe Application ID;
2. Source User Info (Source UE's ProSe Application Layer ID, ProSe Application Layer Group ID);
   NOTE 1: The Broadcasting UE is the Source UE.
3. Target User Info (Target UE's ProSe Application Layer ID);
   NOTE 2: The Target UE is the Listening UE.
4. Relay Service Code (for UE-to-Network Relay Discovery);
5. Discovery Group ID (for Group Member Discovery).

A second component is broadcasting: This procedure consists of the UE broadcasting data that other UEs will be listening for. Depending on the ProSe application that the broadcasting UE is wanting to use, in addition to broadcasting the Origination and Destination Layer-2-IDs, the broadcasting UE may be needed to also broadcast one or more (e.g., any) of the following:
1. ProSe Application ID;
2. Source User Info (Source UE's ProSe Application Layer ID, ProSe Application Layer Group ID);
3. Target User Info (Target UE's ProSe Application Layer ID);
4. Relay Service Code;
5. Discovery Group ID.

### 1.4 UE-to-UE Relay Information from TR

For L2 UE-to-UE Relay architecture, the protocol stacks are similar to L2 UE-to-Network Relay other than the fact that the termination points are two remote UEs.

An adaptation layer is supported over the second PC5 link (i.e. the PC5 link between relay UE and target/destination UE) for L2 UE-to-UE relay. For L2 UE-to-UE relay, the adaptation layer is put over RLC sublayer for both CP and UP over the second PC5 link. The sidelink SDAP/PDCP and RRC are terminated between two remote UEs, while RLC, MAC and PHY are terminated in each PC5 link.

The adaptation layer over first PC5 hop between source remote UE and Relay UE supports to identify traffic destined to different target/destination remote UEs.

The identity information of Remote UE end-to-end Radio Bearer is included in the adaptation layer in first and second PC5 hop.

In addition, the identity information of Source Remote UE and/or the identity information of Destination Remote UE are candidate information to be included in the adaptation layer, which are to be decided in WI phase [2].

### 1.4.1 Control and User Plane Protocols for Layer 2 UE-to-UE Relay

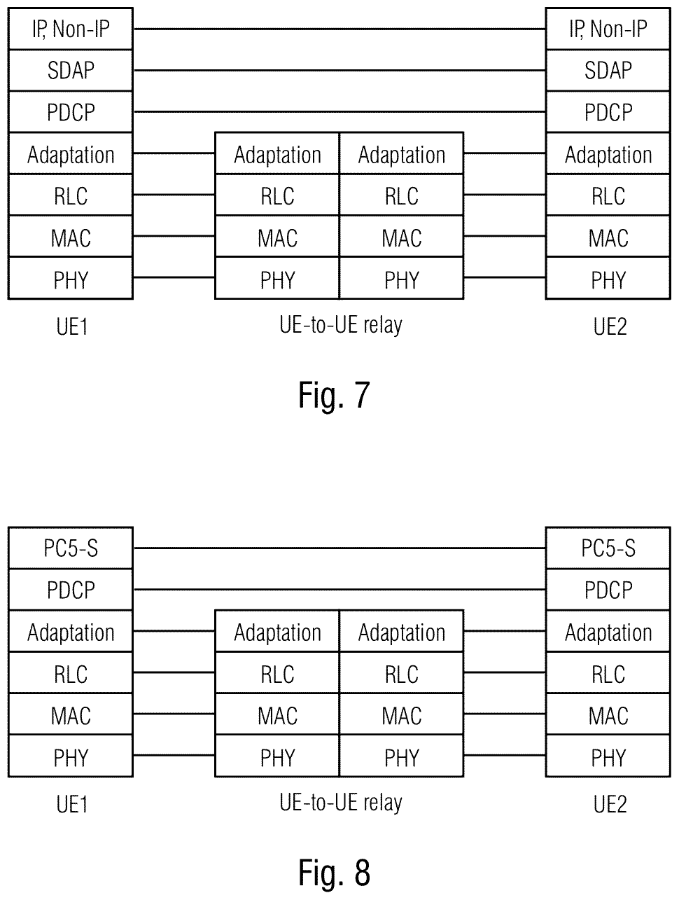

FIG. 7 shows a schematic representation of End-to-End User Plane protocol stacks using a Layer-2 UE-to-UE Relay [1].

As shown in FIG. 7, a first UE (UE1) comprises a IP/non-IP layer or entity, a service data adaption protocol, SDAP, layer or entity, a packet data convergence protocol, PDCP, layer or entity, an adaption layer or entity, a radio link control, RLC, layer or entity, a medium access control, MAC, layer or entity and a physical, PHY, layer or entity. A UE-to-UE relay comprises two adaption layers or entities, two RLC layers or entities, two MAC layers or entities and two PHY n layers or entities. A second UE (UE2) comprises a IP/non-IP layer or entity, a SDAP layer or entity, a PDCP layer or entity, an adaption layer or entity, a RLC layer or entity, a MAC layer or entity and a PHY layer or entity.

FIG. 8 shows a schematic representation of End-to-End Control Plane protocol stacks using a Layer-2 UE-to-UE Relay [1].

As shown in FIG. 8, a first UE (UE1) comprises a PC5 signaling, PC5-S, layer or entity, a packet data convergence protocol, PDCP, layer or entity, an adaption layer or entity, a radio link control, RLC, layer or entity, a medium access control, MAC, layer or entity and a physical, PHY, layer or entity. A UE-to-UE relay comprises two adaption layers or entities, two RLC layers or entities, two MAC layers or entities and two PHY n layers or entities. A second UE (UE2) comprises a PC5-S layer or entity, a PDCP layer or entity, an adaption layer or entity, a RLC layer or entity, a MAC layer or entity and a PHY layer or entity.

In [2], discovery model refers to Model A and Model B that are defined in [3], that are “I am here” and “who is there” approaches for ProSe discovery.

### 1.5 Target UE Discovery Via UE-to-UE Relay

According to [1], there are three methods for UE-to-UE discovery:
1. Source UE tries Direct Communication, if it fails, discovers Relay UE and tries to reach Target UE via Relay
2. Alternative 1: UE-to-UE relay discovery and selection can be integrated into the unicast link establishment procedure as described in clause 6.3.3 of [5].
3. Alternative 2: UE-to-UE relay discovery and selection is integrated into Model B (“Who is there”) direct discovery procedure.

When a source UE wants to communicate with a target UE, it will first try to find the target UE by either sending:
Direct Communication Request, or
Solicitation message with the target UE info.

If the source UE cannot reach the target UE directly, it will try to discover a UE-to-UE relay to reach the target UE which may also trigger the relay to discover the target UE. To be more efficient, this solution tries to integrate target UE discovery and UE-to-UE relay discovery and selection together, including two alternatives:
Alternative 1: UE-to-UE relay discovery and selection can be integrated into the unicast link establishment procedure as described in clause 6.3.3 of TS 23.287.
Alternative 2: UE-to-UE relay discovery and selection is integrated into Model B direct discovery procedure.

In this solution, the source UE can discover the target UE(s) via the relays. It enables target UE to select relays and source UE to select relay path or direct path.

It may exist a situation where multiple UE-to-UE relays can be used to reach the target UE or the target UE may also directly receive the Direct Communication Request or Solicitation message from the source UE. The target UE may choose which one to reply according to e.g. signal strength, local policy (e.g. traffic load of the UE-to-UE relays), Relay Service Code if there is any or operator policies (e.g. direct communication or only use some specific UE-to-UE relays).

The source UE may receive the responses from multiple UE-to-UE relays and may also from the target UE directly, the source UE chooses the communication path according to e.g. signal strength or operator policies (e.g. direct communication or only use some specific UE-to-UE relays) (see [1], 6.8. Solution #8: UE-to-UE Relay Selection without Relay Discovery).

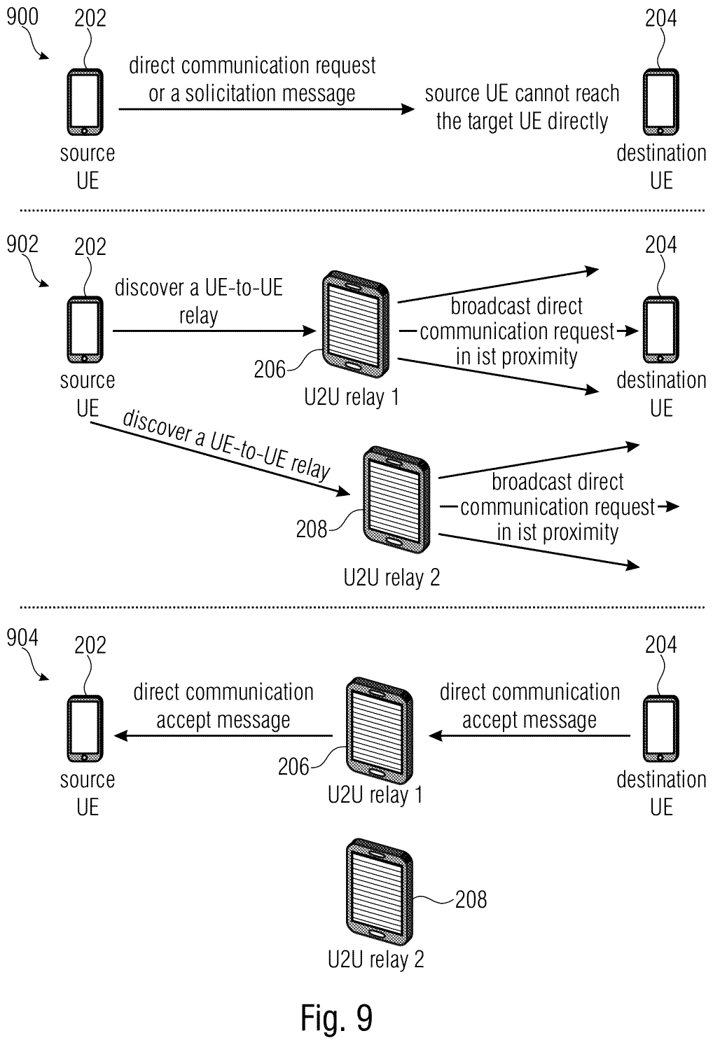

FIG. 9 is a schematic representation of three different scenarios of discovering the target UE via a relay UE.

According to a first scenario 900, a source UE 202 transmits a direct communication request or a solicitation message to a destination UE 204, where in the first scenario it is exemplarily assumed that the source UE 202 cannot reach the destination UE 204 directly.

According to second scenario 902, the source UE 202 discovers two UE-to-UE (U2U) relays 206 and 208, where each of the two UE-to-UE relays 206 and 208 transmits a broadcast direct communication request in its proximity. Thereby, in the second scenario it is exemplarily assumed that the first UE-to-UE relay 206 reaches the destination UE 204.

According to the third scenario, the destination UE 204 transmits a direct communication accept message to the first UE-to-UE relay 206, where the first UE-to-UE relay 206 transmits a direct communication accept message to the source UE 202.

Thereby, a discovery message can be transmitted using PC5 communication channel.

Model A procedure is applicable to those UEs which are not sensitive to power consumption. Because announcing UE broadcasts direct discovery message periodically.

When the UE-to-UE Relay is out of coverage, it can act as a UE-to-UE Relay based on the preconfigured policy and parameters [1].

### 1.6 Information Content During UE-to-UE Relay Discovery and Selection

During UE-to-UE relay discovery and selection, the following information content can be transmitted (e.g., broadcast) from source UE to relay UE: Source UE info, target UE info, Application ID, and/or Relay Service Code if there is any (e.g., Layer-2 ID, ProSe Application ID, UE's Application Layer ID, target UE's Application Layer ID and/or relay applicable indication).

During UE-to-UE relay discovery and selection, the following information content can be transmitted from relay UE to target/destination UE and optionally also to the source UE: Source UE info, target UE info and relay UE info (e.g., Relay UE ID) and/or relay's L2 address as the source Layer-2 ID.

During UE-to-UE relay discovery and selection, the following information content can be transmitted from target/destination UE to Relay UE: Source UE info, Relay UE info, and/or target/destination UE info.

During UE-to-UE relay discovery and selection, the following information content can be transmitted from Relay UE to Source UE: Source UE info, Relay UE info, and/or target/destination UE info.

### 2. Embodiments

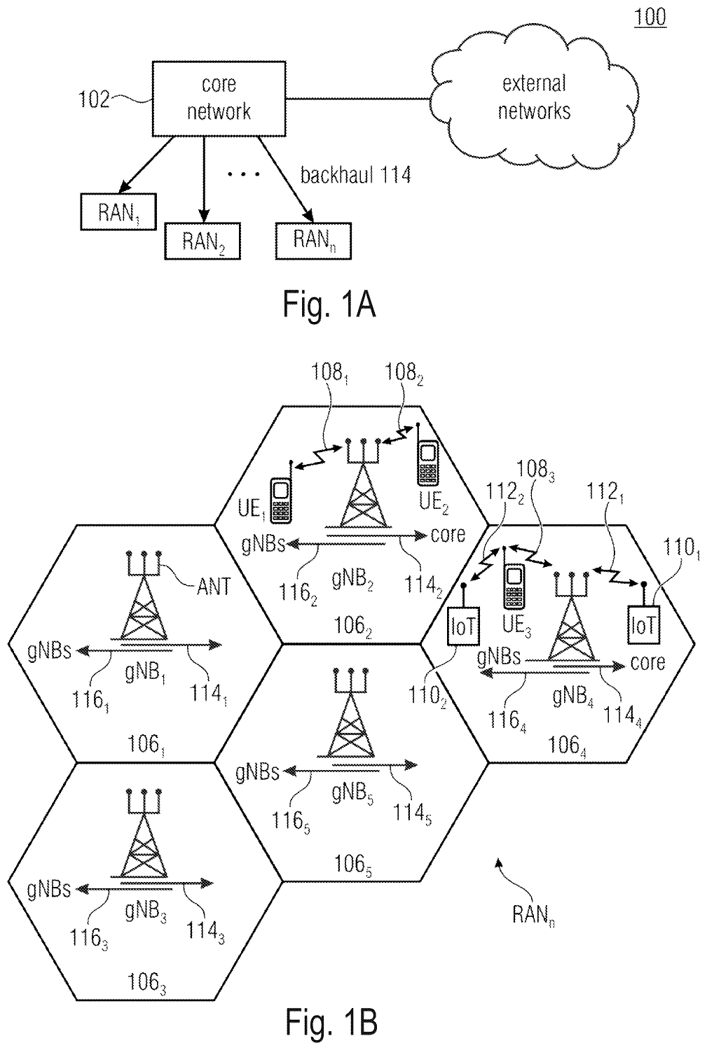

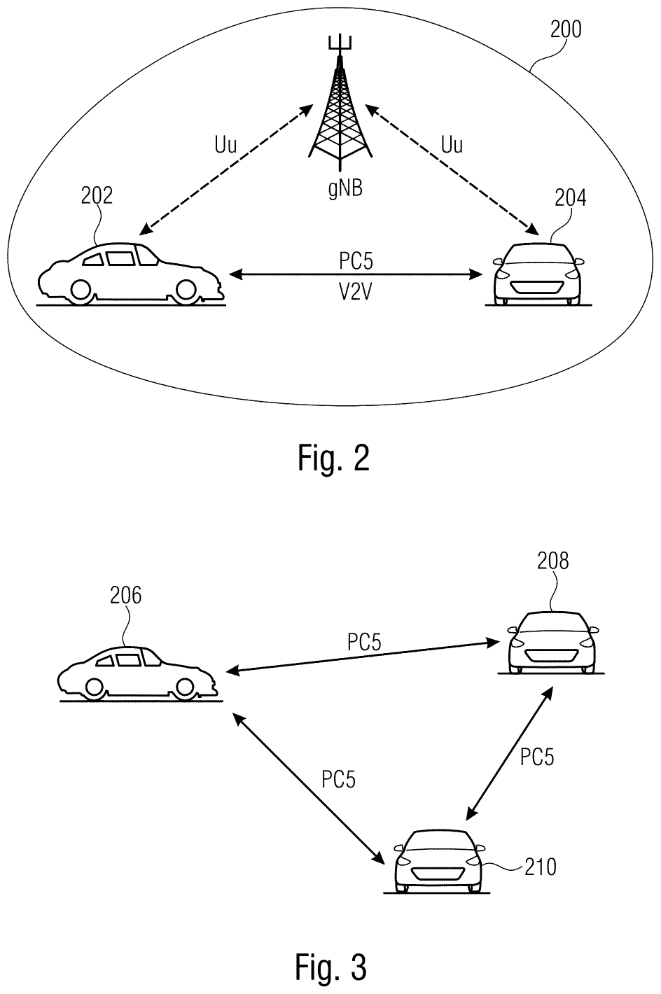

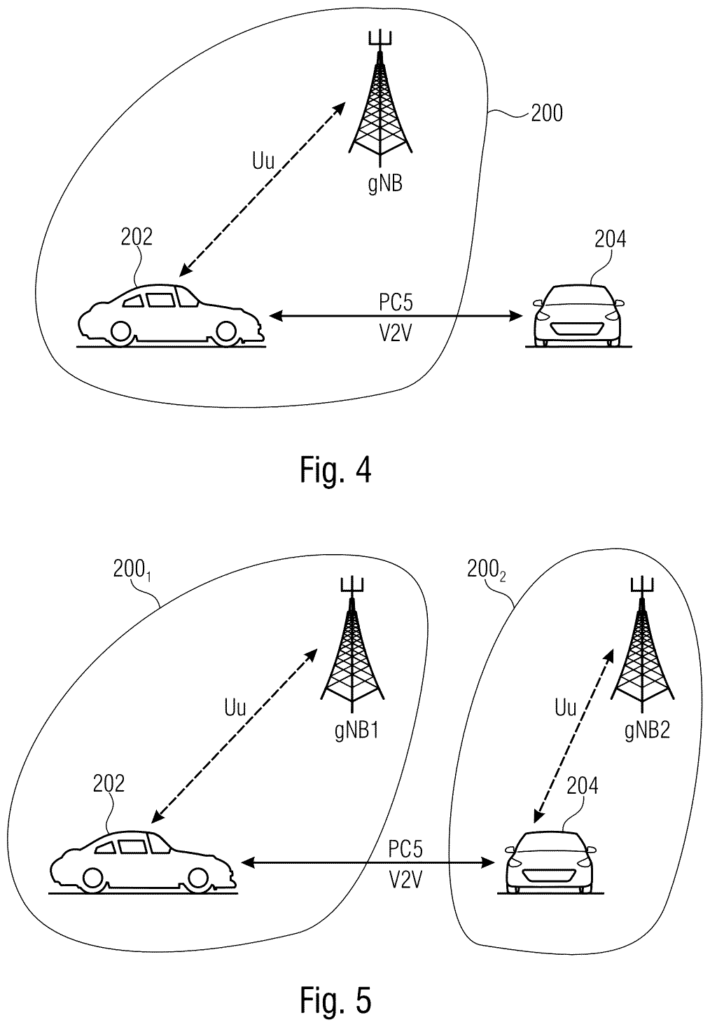

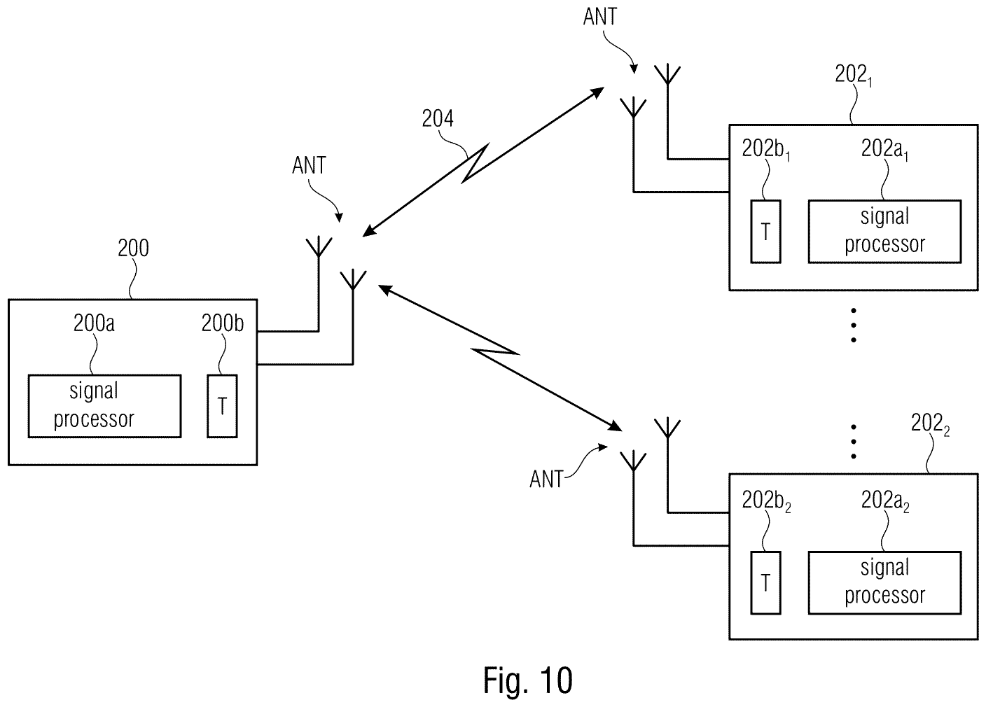

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 10 is a schematic representation of a wireless communication system comprising a transceiver 200, like a relay, and a plurality of communication devices 2021 and 2022, like UEs. The UEs might directly communicate with the relay 200 via a wireless communication link or channel 203, like a radio link (e.g., using the PC5 interface (sidelink)). The relay 200 might relay messages between the UEs 2021 and 2022, such that the UEs 2021 and 2022 can communicate with each other via the relay 200. The relay 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202a2, and a transceiver (e.g., receiver and/or transmitter) unit 202b1 to 202b2. The base station 200 and/or the one or more UEs 202 may operate in accordance with the inventive teachings described herein.

Embodiments provide a UE [e.g., source UE] of a wireless [e.g., radio based] communication system [e.g., 5G/NR communication system], wherein the UE is configured to operate in a sidelink mode of operation [e.g., 5G/NR sidelink mode 1 or mode 2], wherein the UE is configured, for establishing a connection with a target UE or a group of target UEs [e.g., the group of target UEs having a group ID] via a UE-to-UE relay, to transmit [e.g., via the sidelink] a discovery message for discovering one or more candidate relay UEs that are connected or able to connect [e.g., via the sidelink] to the target UE or group of target UEs.

In embodiments, the discovery message comprises an information about the target UE or group of target UEs [e.g., layer 2 destination ID], source UE and/or other relevant information.

In embodiments, the UE is configured to receive a discovery response message from one or more candidate relay UEs that are connected or able to connect to the target UE or group of target UEs, wherein the UE is configured to select a relay UE out of the one or more candidate relay UEs.

In embodiments, the UE is configured to establish a connection with the target UE or group of target UEs via the selected relay UE.

In embodiments, the UE is configured to select the relay UE out of the one or more candidate relay UEs in dependence on a selection criterion, wherein the selection criterion is pre-configured or signaled by a base station of the wireless communication network or configured by higher layers.

In embodiments, the selection criterion is at least one out of
a signal strength [e.g., reference signal received power, RSRP] of a link between the UE and the respective relay UE,
a signal strength [e.g., reference signal received power, RSRP] of a link between the respective relay UE and the target UE,
a load of the respective relay UE, [e.g. CPU, memory, temperature, channel busy ration, CBR, buffer status, channel occupancy ratio]
a number of remote UEs connected to the respective relay UE,
a data rate supported by the respective relay UE,
capabilities of the respective relay UE,
an information received from a higher layer,
a received radio resource control, RRC, message.
a signal strength of discovery messages.

In embodiments, the UE is configured, when the UE is in-coverage of a base station of the wireless communication system, to select the one relay UE out of the one or more candidate relay UEs in dependence on an assistance information or control information received from the base station.

In embodiments, the UE is configured, when the UE is in-coverage a base station of the wireless communication system, to transmit the discovery message only to those candidate relay UEs indicated by a control information received from the base station.

In embodiments, the UE is configured to select another relay UE for communicating with the target UE or group of target UEs if a reselection criterion is fulfilled and/or in response to a reception of a reselection control message [e.g., received from a base station, the current relay UE, the target UE] [e.g., controlling the UE to reselect a relay UE].

In embodiments, the UE is configured, when the reselection criterion is fulfilled or in response to the reception of the reselection control message, to select the other relay out of the one or more candidate relay UEs.

In embodiments, the UE is configured, when the reselection criterion is fulfilled or in response to the reception of the reselection control message, to transmit a further discovery message for discovering one or more candidate relay UEs that are connected or able to connect [e.g., via the sidelink] to the target UE or group of target UEs, wherein the UE is configured to receive a further discovery response message from one or more candidate relay UEs that are connected or able to connect to the target UE or group of target UEs, wherein the UE is configured to select the other relay UE out of the one or more candidate relay UEs.

In embodiments, the UE is configured to transmit a reselection information message to the relay UE, the reselection information message informing the relay UE for handover to the other relay UE about the selected other relay UE, or wherein the UE is configured to transmit a reselection information message to a base station, the reselection information message informing the base station about the selected other relay UE and requesting the base station to coordinate the handover to the selected other UE.

In embodiments, the reselection criterion is at least one out of
a signal strength [e.g., reference signal received power, RSRP] of a link between the UE and the relay UE [e.g., is below a threshold],
a signal strength [e.g., reference signal received power, RSRP] of a link between the relay UE and the remote UE [e.g., is below a threshold],
one or more QoS parameters [e.g., are below or above a threshold],
a load of the relay UE [e.g., is above a threshold],
a battery status of the relay UE [e.g., is below a threshold],
an information received from a higher layer,
a control message received from the relay UE or base station indicating that the relay UE stops relay operation.

Further embodiments provide a relay UE [e.g., UE-to-UE relay] of a wireless [e.g., radio based] communication system [e.g., 5G/NR communication system], wherein the relay UE is configured to operate in a sidelink mode of operation [e.g., 5G/NR sidelink mode 1 or mode 2], wherein the relay UE is configured to receive a discovery message from a source UE, the discovery message indicating a target UE or a group of target UEs [e.g., the group of target UEs having a group ID; e.g., the relay UE being part of the group of UEs] to which the source UE requests a relaying of messages, wherein the relay UE is configured, in case the relay UE is able to relay messages between the source UE and the target UE or group of target UEs, to transmit a discovery message response to the source UE, the discovery message response indicating that the relay UE is able to relay messages between the source UE and the target UE or group of target UEs.

In embodiments, the discovery message comprises an information about the target UE or group of target UEs [e.g., layer 2 destination ID], source UE and/or other relevant information.

In embodiments, the relay UE is configured to transmit, in response to the reception of the discovery message, a target UE or group of target UEs discovery message for discovering the target UE or group of target UEs.

In embodiments, the relay UE is configured to transmit the discovery message response to the source UE in response to a reception of a target UE or group of target UEs discovery message response from the target UE or group of target UEs.

In embodiments, the relay UE is configured to maintain a list of remote UEs the relay UE is connected to or able to connect to, wherein the relay UE is configured to directly transmit the discovery message response to the source UE in case that the target UE is included in the list of remote UEs.

In embodiments, the relay UE is configured, in case that the relay UE is in-coverage of a base station of the wireless communication network, to share the list of remote UEs with the base station.

In embodiments, the relay UE is configured to transmit remote UE discovery messages [e.g., periodically or at pre-defined or random time-instances] for discovering remote UEs, wherein the relay UE is configured to update the list of remote UEs in dependence on the remote UE discovery response messages received form the discovered remote UEs.

In embodiments, the relay UE is configured to hold additional information about the remote UEs in the list of remote UEs to further support relaying of messages and/or answering discovery messages.

In embodiments, the discovery response message further includes an information about the target UE.

In embodiments, discovery response message further includes a list of one or more remote UEs the relay UE is connected to or able to connect to.

In embodiments, the discovery response message further includes an information about the one or more remote UEs.

In embodiments, the information about the one or more remote UEs is, for each of the one or more remote UEs, at least one out of
supported application IDs,
active group IDs
received signal strength indicator, RSSI, readings,
an address information [e.g., layer 2 IDs of layer 3 address information],
UE type,
UE velocity or mobility indicator,
UE position (relative or absolute).

In embodiments, the discovery response message further includes an information about the relay UE.

In embodiments, the information about the relay UE is at least one out of
a remaining battery level of the relay UE or battery status,
a discontinuous reception, DRX, configuration of the relay UE,
a number of remote UEs connected to the relay UE,
a list of remote UEs the relay UE is connected to or able to connect to,
a list of supported application of service IDs,
a list of supported groups or an indication that all groups are supported,
a list of supported public land mobile networks, PLMNs, and/or stand-alone non-public networks, SNPNs,
buffer state information,
type of the relay UE (e.g. L2 or L3, UE-to-UE or UE-to-Network),
network connection information [e.g. whether the relay UE is connected to a network, the cell ID],
channel busy ratio (CBR) at relay.

In embodiments, the relay UE is configured, upon receiving a reselection information message from one out of the source UE, target UE and base station, the reselection information message informing the relay UE about a handover to another relay UE, to transmit a further reselection information message to the other one out of the source UE, target UE and base station, the further reselection information message informing about the selected other relay UE.

In embodiments, the relay UE is configured to handover the traffic between the source UE and the target UE to the other relay UE at a time indicated in the reselection information message.

In embodiments, the relay UE is configured to transmit a relay reselection control message to the source UE and/or target UE and/or base station in case that a relay reselection criterion is fulfilled, the relay resection control message controlling the source UE and/or target UE and/or base station to select another relay UE.

In embodiments, the relay reselection criteria is at least one out of
a signal strength [e.g., reference signal received power, RSRP] of a link between the UE and the relay UE [e.g., is below a threshold],
a signal strength [e.g., reference signal received power, RSRP] of a link between the relay UE and the remote UE [e.g., is below a threshold],
one or more QoS parameters [e.g., are below or above a threshold],
a load of the relay UE [e.g., is above a threshold],
a battery status of the relay UE [e.g., is below a threshold],
an information received from a higher layer,
an information or control message from the base station,
a relay operation termination criterion.

In embodiments, the relay UE is configured to stop relaying in case that a relay operation termination criterion is reached.

In embodiments, the relay UE is configured to transmit a control message to the source UE and/or target UE and/or base station indicating that the relay UE stops relaying in case that the relay operation termination criterion is reached.

In embodiments, the relay operation termination criterion is one out of
a critical battery level of the relay UE,
a reinitiation of an operating system of the relay UE,
a hardware failure of the relay UE,
a reconfiguration of the relay UE [e.g. by higher layer].
one or more QoS parameters [e.g., are below or above a threshold],
a load of the relay UE [e.g., is above a threshold],
a battery status of the relay UE [e.g., is below a threshold],
an information received from a higher layer,
an information or control message from the base station,
a relay operation termination criterion.

Further embodiments provide a target UE of a wireless [e.g., radio based] communication system [e.g., 5G/NR communication system], wherein the target UE is configured to operate in a sidelink mode of operation [e.g., 5G/NR sidelink mode 1 or mode 2], wherein the target UE is configured to communicate with a source UE of the wireless communication network via a relay UE of the wireless communication network, wherein the target UE is configured
to reselect another relay UE
or to transmit a relay reselection control message to the source UE, the relay reselection control message controlling the source UE and/or the base station to select another relaying UE
   when a reselection criterion is fulfilled.

In embodiments, the reselection criterion is at least one out of
a signal strength [e.g., reference signal received power, RSRP] of a link between the UE and the relay UE [e.g., is below a threshold],
a signal strength [e.g., reference signal received power, RSRP] of a link between the relay UE and the remote UE [e.g., is below a threshold],
one or more QoS parameters [e.g., are below or above a threshold],
a load of the relay UE [e.g., is above a threshold],
a battery status of the relay UE [e.g., is below a threshold],
an information received from a higher layer,
a control message received from the relay UE indicating that the relay UE stops relay operation.

In embodiments, the target UE is configured to reselect another relay by transmitting a discovery message for discovering one or more candidate relay UEs that are connected or able to connect [e.g., via the sidelink] to the source UE, wherein the target UE is configured to select the other relay UE out of the one or more candidate relay UEs that are connected or able to connect [e.g., via the sidelink] to the source UE.

In embodiments, the target UE is configured to reselect the other relay UE out of the one more candidate relay UEs in dependence on a selection criterion.

In embodiments, the target UE is configured to transmit a reselection information message to the relay UE, the reselection information message informing the relay UE for handover to the other relay UE about the selected other relay UE, or wherein the target UE is configured to transmit a reselection information message to a base station, the reselection information message informing the base station about the selected other relay UE and requesting the base station to coordinate the handover to the selected other UE.

Further embodiments provide a wireless [e.g., radio based] communication system [e.g., 5G/NR communication system]. The communication system comprises a source UE according to one of the embodiments described herein, a relay UE according to one of the embodiments described herein and a target UE according to one of the embodiments described herein.

Further embodiments provide a method for operating a UE [e.g., source UE] of a wireless [e.g., radio based] communication system [e.g., 5G/NR communication system]. The method comprises a step of operating the UE in a sidelink mode of operation [e.g., 5G/NR sidelink mode 1 or mode 2]. Further, the method comprises a step of transmitting, for establishing a connection with a target UE or a group of target UEs via a UE-to-UE relay, a discovery message for discovering one or more candidate relay UEs that are connected or able to connect [e.g., via the sidelink] to the target UE or group of target UEs.

Further embodiments provide a method for operating a relay UE [e.g., UE-to-UE relay] of a wireless [e.g., radio based] communication system [e.g., 5G/NR communication system]. The method comprises a step of operating the relay UE in a sidelink mode of operation [e.g., 5G/NR sidelink mode 1 or mode 2]. Further, the method comprises a step of receiving a discovery message from a source UE, the discovery message indicating a target UE or a group of target UEs to which the source UE requests a relaying of messages. Further, the method comprises a step of transmitting, in case the relay UE is able to relay messages between the source UE and the target UE or group of target UEs, a discovery message response to the source UE, the discovery message response indicating that the relay UE is able to relay messages between the source UE and the target UE or group of target UEs.

Further embodiments provide a method for operating a target UE of a wireless [e.g., radio based] communication system [e.g., 5G/NR communication system]. The method comprises a step of operating the target UE in a sidelink mode of operation [e.g., 5G/NR sidelink mode 1 or mode 2]. Further, the method comprises a step of communicating with a source UE of the wireless communication network via a relay UE of the wireless communication network. Further, the method comprises a step of reselecting another relay UE or transmitting a relay reselection control message to the source UE, the relay reselection control message controlling the source UE to select another relaying UE, when a reselection criterion is fulfilled.

Embodiments provide a mechanism to support single-hop L2 and/or L3 UE-to-UE relay for unicast transmission.

In embodiments, a source UE is defined as a UE that identifies the candidate UE-to-UE relays, and initiates relay reselection via the existing connection. Sends a message to a target UE, either directly or via a relay UE. The source UE is a remote UE.

In embodiments, a target UE is a remote UE that receives a message from a source UE or from a relay UE. Also called destination UE.

In embodiments, a target group is a group of UEs, e.g., a destination in groupcast communication, that can have a single group ID as target address.

In embodiments, a remote UE is UE that may be connected to a relay UE. A source UE and a target/destination UE is a remote UE, the relay UE is not a remote UE.

In embodiments, a UE-to-UE relay sends sends/receives discovery messages to/from the source UE or the target UE [1] (6.50.3 Impacts on services, entities and interfaces).

In embodiments, a user info ID is defined as follows. For Model A, this corresponds to the announcer info parameter when the UE is acting as an announcing UE. For Model B, this corresponds to the discoverer info in solicitation messages and the discoveree info in response messages, when the UE is acting as a discoverer or discoveree UE respectively.

In embodiments, a relay service code (TS 23.303) can be used to identify a connectivity service the ProSe UE-to-Network relay provides, and the authorized users the ProSe UE-to-Network relay would offer service to, and may select the related security policies or information e.g. needed for authentication and authorization between the Remote UE and the ProSe UE-to-Network relay.

In embodiments, a relay service code(s) (TR 23.752) identifies a connectivity service the ProSe UE-to-UE relay provides to applications. The relay service codes are configured in the ProSe UE-to-UE Relays that provide connectivity services to applications. The relay service codes are configured in the remote UEs interested in related connectivity services [1] (6.36.2.4 5G ProSe UE-to-UE Relay Discovery parameters).

In embodiments, Relay_indication is a flag that indicates whether relays can be used in the communication (e.g. when a source UE wants to broadcast a direct communication request or a solicitation message, it indicates in the message whether a UE-to-UE relay could be used).

In embodiments, relay selection is a process of selecting or reselecting a relay.

Subsequently, embodiments of the present invention are described in further detail.

### 2.1 Use Cases

Embodiments described herein mainly focus on one or more of the following scenarios.

In embodiments, a source UE has a PC5 connection with a target UE and the link quality does no longer allow a reliable communication. The source UE decides to use a relay UE, if possible, to reach the target UE.

In embodiments, a source UE is looking for target UEs in reach that support a certain service/application to connect with these. Examples for this might be: PTT application for a special group, i.e. firefighters; multi-player games; road services that use an RSU as relay UE.

In embodiments, a source UE know about the existence of another target UE and wants to connect to that specific one, either because the application know the target ID already, or there is a known group ID for a number of devices. Some of these could be directly attached, but some might only be reachable by a relay UE.

In embodiments, a basic setup is that a source UE is connected to a relay UE, where the relay UE is connected to the target UE (i.e. Source UE(S)<->Relay UE (R)<->Target UE (T)).

In embodiments, there could be also a scenario where source and target UE do not know about the relay UE at all. In other words, there could be a PC5 link between source UE and relay UE and a PC5 link between relay UE and target UE, where source UE and target UE do not know about the relay UE. In this case, discovery relay can help both sides to ‘discover’ the connection between source UE and target UE.

In embodiments, within the relay UE, an adaptation layer can map incoming PC5 messages to out coming PC5 messages in order to relay the messages to the correct target UE.

In embodiments, decision for route planning can be made by
target UE (destination UE), and/or
source UE, and/or
relay UE, and/or
base station.

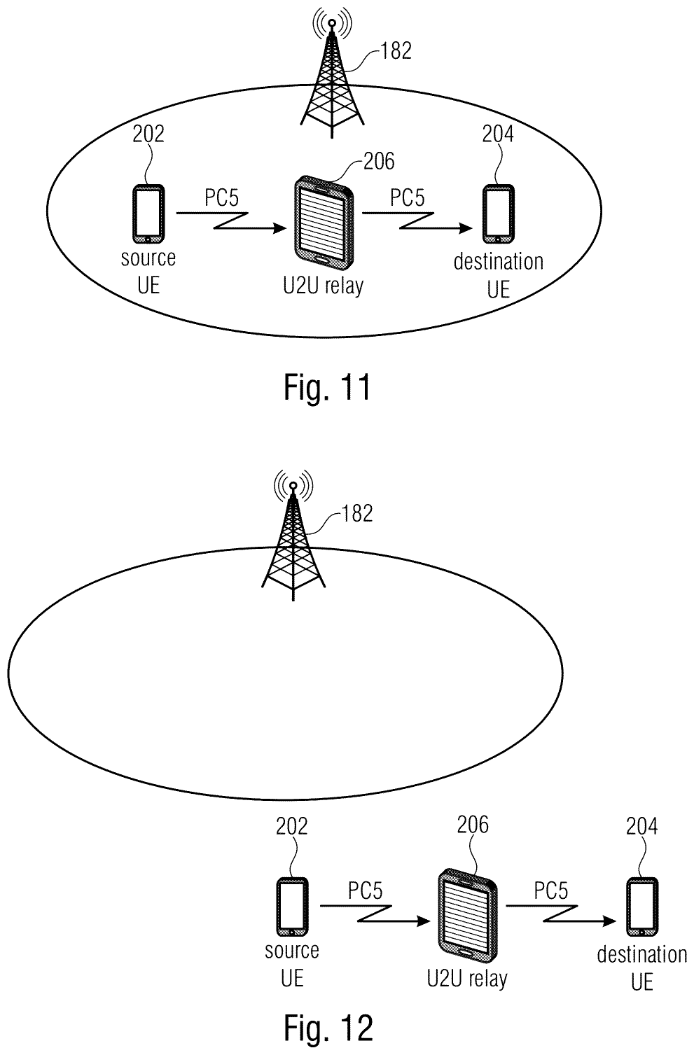

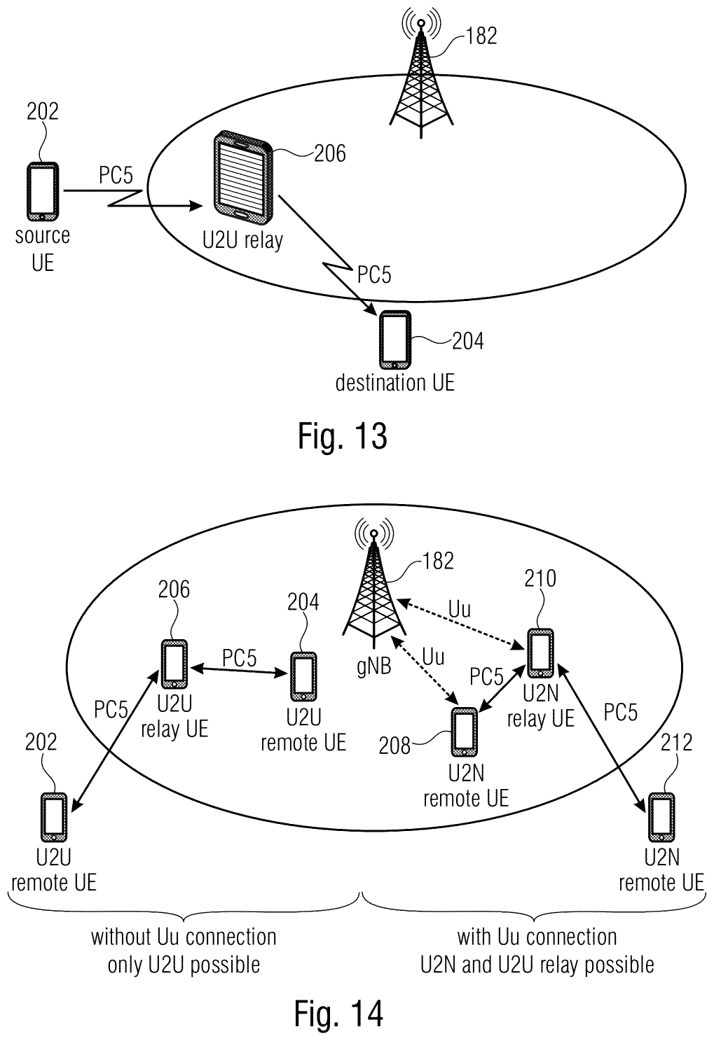

Embodiments consider three coverage scenarios (see [2], 5.1). According to a first coverage scenario, both UEs are in in-coverage, as indicated in FIG. 11. Specifically, FIG. 11 shows a schematic representation of a wireless communication network having a base station 182, a source UE 202, a destination UE 204 and a UE-to-UE relay 206, where source UE 202, destination UE 204 and UE-to-UE relay 206 are in-coverage of the base station 182 [2]. According to a second coverage scenario, both UEs are in out-of-coverage, as indicated in FIG. 12. Specifically, FIG. 12 shows a schematic representation of a wireless communication network having a base station 182, a source UE 202, a destination UE 204 and a UE-to-UE relay 206, where source UE 202, destination UE 204 and UE-to-UE relay 206 are out-of-coverage of the base station 182 [2]. According to a third coverage scenario, at least one UE is in-coverage and at least one UE is out-of-coverage, as indicated in FIG. 13. Specifically, FIG. 13 shows a schematic representation of a wireless communication network having a base station 182, a source UE 202, a destination UE 204 and a UE-to-UE relay 206, where the UE-to-UE relay 206 is in-coverage of the base station 182, and where source UE 202 and destination UE 204 are out-of-coverage of the base station 182 [2].

Furthermore, there could be also a scenario where one UE is in-coverage in one cell and another UE is in-coverage in another cell.

FIG. 14 shows a schematic representation of a wireless communication system comprising in-coverage and out-of-coverage UEs. In FIG. 14 it is exemplarily assumed that UEs 202, 204 and 206 are in-coverage a base station 182 (gNB) of the wireless communication network, where UEs 208, 210 and 212 are out-of-coverage. For example, out-of-coverage remote UEs 202 and 204 can communicate with each other via an out-of-coverage relay UE 206 using respective PC5 links. Further, in-coverage UEs 208 and 210 can be connected to the base station 182 (gNB) of the wireless communication network via respective Uu links. The two in-coverage UEs 208 and 210 also can be connected directly to each other via a PC5 link. In this case, an out-coverage-UE 212 might communicate with UE 208 via UE 210, wherein UE 210 might serve as a U2N relay (i.e. messages are relayed by UE 210 via the base station to UE 208 using the respective Uu links) or a U2U relay (i.e. messages are relayed by UE 210 directly to UE 208 via the PC5 link).

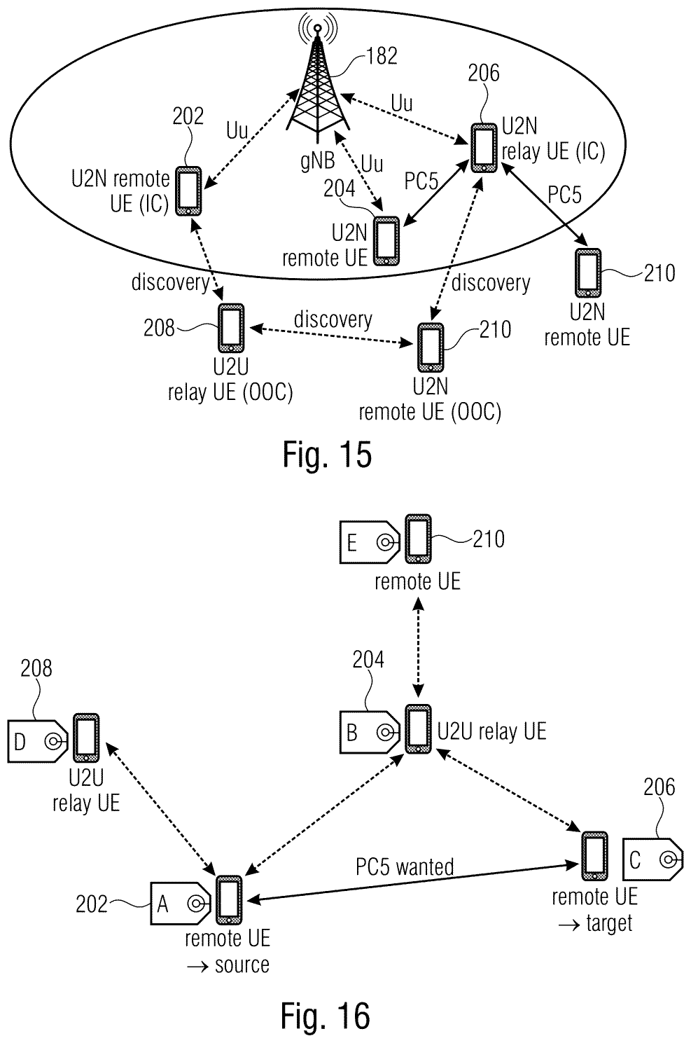

FIG. 15 shows a schematic representation of a wireless communication system comprising in-coverage and out-of-coverage UEs. In FIG. 15 it is exemplarily assumed that UEs 202, 204 and 206 are in-coverage a base station 182 (gNB) of the wireless communication network, where UEs 208, 210 and 212 are out-of-coverage. Thereby, UEs 202, 204 and 206 are connected to the base station 182 via Uu links, where UEs 204 and 206 also can be connected directly to each other via a PC5 link. Out-of-coverage UEs 208, 210 and 212 can perform a discovery procedure for detecting UEs that might serve as a relay for communicating with other UEs of the wireless communication network.

In a wireless communication system as described above, such as in a wireless communication system as exemplarily illustrated in FIGS. 14 and 15, embodiments allow for a UE to know, which other UEs are available via Sidelink.

Further, embodiments allow for a remote UE to know which relay UE is connected or able to connect to which other remote UEs. Thereby, in embodiments, a UE can know the destination ID before a selection of a relay UE. Further, in embodiments, a UE can select a relay UE and then ask the relay UE which other UEs are attached. Further, in embodiments, it is also possible that a UE does not know the target IP. In that case, selection of a relay UE is random. Further, in embodiments, the UE-to-UE relay can be a unicast link or a broadcast to all connected remote UEs.

In this regard it is noted that in a UE-to-UE relay, the U2N discovery cannot be reused completely, because the target ID might be missing. It is not a requirement to know the target ID of the target UE upfront. In model B, the source UE can ask “Who is there” to discover that.

Embodiments provide an assistance information in PC5.

Embodiments provide a list of target UEs.

Embodiments define what a Relay UE is answering to in a Model B (Who is there) discovery message.

In embodiments, a relay UE can just forward a discovery message from source UE to target UE.

In embodiments, a relay UE can alter the discovery message (e.g., source ID) and then forward the altered discovery message to the target Ue.

Embodiments provide a relay indication flag, wherein if the flag is true, then the message can be relayed.

In embodiments, the remote UE can obtain from U2N a list of possible relay nodes, wherein the UE can choose one relay UE of the possible relay UEs of the list.

### 2.2 Embodiment 1—Discovery

It is noted that, while the below embodiments are described by way of example making reference to relay selection and single-hop scenarios, the below described embodiments also apply to relay reselection and/or multi-hop scenarios.

In embodiments, there are three options for a discovery:
source UE initiates the discovery,
target/destination UE initiates the discovery, and/or
relay UE initiates the discovery.

### 2.2.1 Embodiment 1.1: Discovery Procedure for Ue-to-Ue Relay

Embodiments solve the problem for a UE-to-UE endpoint (or UE-to-UE relay scenario) of how the source UE knows about the most appropriate relay UE to reach a certain target UE. Further, embodiments allow for the source UE to select the right relay UE.

In embodiments, the source UE sends out ‘backward discovery message’ to ask for relays with a certain UE connected.

Note that this procedure may apply to in-coverage, out-of-coverage and PC5; L2 and L3 relay and mode 1 and mode 2 resource allocation (see [1] Model A (“I am here”) and Model B (“who is here”)).

In embodiments, discovery can be initiated by one out of:
source UE,
target UE,
relay UE,
gNodeB (trigger discovery).

FIG. 16 shows a schematic representation of a U2U relay. Specially, in FIG. 16 five UEs are shown, where it is exemplarily assumed that a first UE 202 is connected via respective PC5 links to a second UE 204 and a fourth UE 204, where the second UE 204 is connected via respective PC5 links to a third UE 206 and a fifth UE 210. In this case, the second UE 204 can serve as a U2U relay for the first UE 202 as source UE, which wants to communicate with the third UE 206 as target UE.

In embodiments, when a source UE, which may be in coverage of a gNodeB or out-of-coverage, decides to connect to a target UE via the UE-to-UE Relay (e.g. it lost PC5 connection to target UE), first it broadcast/groupcast its request (Model B discovery) to find potential UE-to-UE Relays in its proximity. Among these relays, some of them might be a good candidate to be selected (e.g. they have discovered the target UE, discover the target UE based on the discovery message, or they have already a PC5 connection to target UE). At this stage, source UE compares the radio signal strength measurements of “Sidelink Discovery Response Messages” received from different UE-to-UE Relays and selects the best UE-to-UE Relay based on thresholds that are either pre-configured or signalled by gNodeB. Besides the RSRP, other criteria are possible as well. See Embodiment 2.1: Selection Criteria vor SL Relay for details.

In embodiments, after PC5 connection establishment, UE-to-UE Relay can maintain a list of remote UE (source and target) IDs in case of another source UE aims to make connection with them. Therefore, one source UE, might be a target UE for another source UE. In this way, signalling between UE-to-UE Relay and remote UEs can be reduced.

In embodiments, if the relay UE is in-coverage, the list of connected and discovered remote UEs could also be sent to the gNodeB to assist other remote UEs in selecting the right relay UE.

Also, the gNodeB can assign a relay to a source UE or a target UE. The gNodeB can transmit further assistance information to remote UEs to enable them to find a suitable relay, e.g. one or more out of the selection criteria that may be used in a discovery response (see section 2.3.1, Embodiment 2.1: Selection Criteria vor SI Relay).

In embodiments, in an in-coverage scenario, the in-coverage source UE can tell the gNodeB about the discovery, can receive configuration of discovery from the gNodeB and get information about relay selection. Decision can be taken by gNodeB or the UE with the help of assistance information (e.g., from the gNodeB or the relay UE) to help to find an appropriate relay UE. It may be possible also for the in-coverage UE to query the gNB about known relays prior to sending any discovery. This may allow, for example, to white or black list relays based on policy or security settings.

In embodiments, in an out-of-coverage scenario, the UE (e.g., source UE) can autonomously select a relay UE based on pre-configured parameters (one or more). The pre-configuration can also be taken from a previous connection with a gNodeB that is valid for a certain time.

In embodiments, in a partial-coverage scenario, at least one of the UEs is out-of-coverage and at least one of the UEs is in-coverage. In this case, the in-coverage device is able to receive parameters from the gNodeB whereas the out-of-coverage device relies on either pre-configured parameters or saved parameters from a previous connection to a gNodeB.

In embodiments, instead of a single target UE, the source UE can also discover a target group (=group of UEs) that can be identified by a group ID. The relay node (or relay UE) can be member of this group.

### 2.2.2 Embodiment 1.2: Source UE Initiates Discovery Procedure (Out-of-Coverage Scenario)

In addition to Embodiment 1.1: Discovery Procedure for Ue-to-Ue Relay, a remote UE may also start the discovery procedure. This may be particularly useful if the UE has no other connectivity at all (out-of-coverage). The remote UE would then send information about which type of application or group it would like to join. It may include indication if it would like to do communication to the network, to other UEs or both.

In embodiments, other UEs such as a UE-to-UE relay may respond to the message informing that it can fulfil the request of the remote UE and connect it to other UEs or to the network if the UE is a U2N relay and in-coverage.

Beside the discovery procedure described in section 1.4 (UE-to-UE Relay Information from TR), an alternative solution could be as follows:

In embodiments, it is assumed that UE-to-UE Relay UE has a list of connected/discovered remote UEs (either source or target or target group) or even other relay UEs.

In embodiments, a source UE which is not connected to Relay UE, broadcasts/groupcasts a discovery message (model B) which contains target UE L2 ID. All potential relay UEs will receive this discovery message and the ones which are connected to the target UE will respond the source UE.

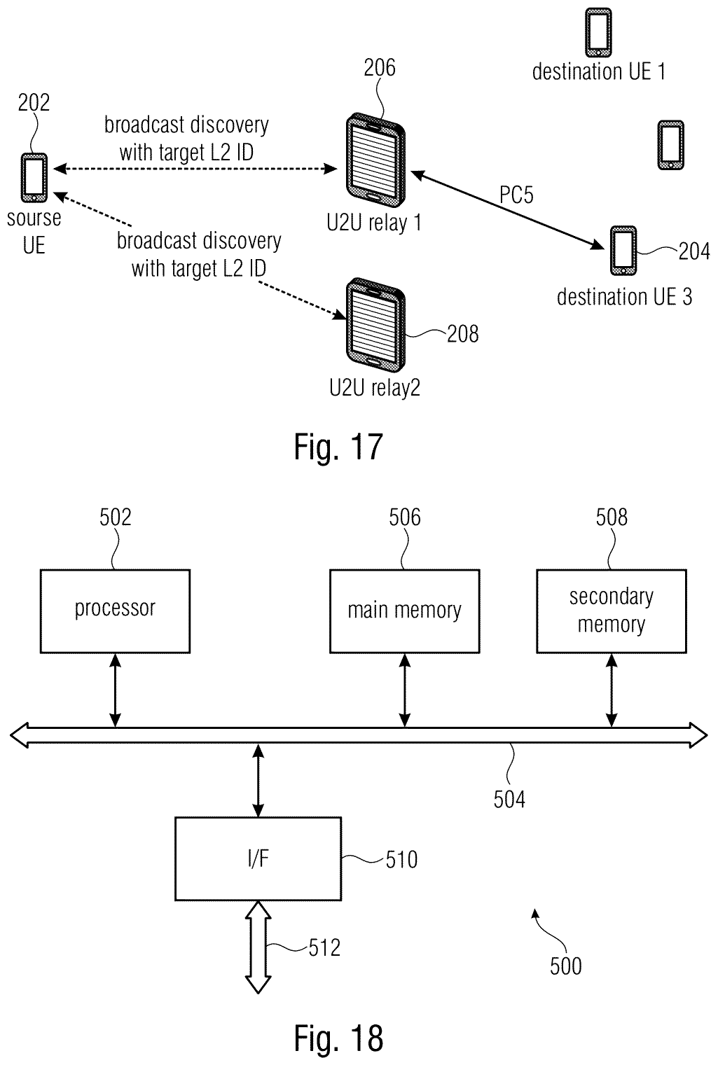

FIG. 17 shows a schematic representation of a source UE initiating discovery procedure. As exemplarily shown in FIG. 17, a source UE 202 can transmit a broadcast discovery with a target layer 2 ID two first and second potential relay UEs, 206 and 208, where only the first potential relay UE 206 is connected to the target UE 204 described by the target layer 2 ID. Thereby, the potential relay UEs can have a list of remote UEs to which they are connected or able to connect.

Because the relay UEs have already a connection (i.e. PC5) to the target UE, there is no need for relaying the discovery message or initiating a discovery procedure to discover the target UE.

In order to make a well informed decision, the relay UE can ask connected UEs for their supported application IDs and thus can choose to forward the discovery message from a source UE to a target UE in case the application ID does not match the current list of supported IDs for the remote UE.

### 2.2.3 Embodiment 1.3: Relay UE Initiates Discovery Procedure

In embodiments its assumed that UE-to-UE Relay UE has a list of connected remote UEs (either source or target).

In embodiments, relay UE can broadcast/groupcast discovery message periodically (model A) to receive discover response messages from remote UEs. Depending on the RRSI and/or other criteria, the relay UE can add suitable UEs (L2 ID) to its list of ‘available’ remote UEs.

If the L2 ID in its list matches with the L2 ID that source UE aims to connect with, PC5 connection can be established.

### 2.2.4 Embodiment 1.4: Content of Discovery (Response) Message

In embodiments, target UE information can be put in discovery message from relay UE.
[1] mentions w.r.t. discovery: “Alternative 2: UE-to-UE relay discovery and selection is integrated into Model B (“Who is there”) direct discovery procedure.”

This alternative would actually enable also to have a list of connected/discovered UEs in the relay to answer requests faster (without explicit discovery).

IN embodiments, the discovery (response) message sent out by the relay UE can include additional information about remote UEs. The relay UE holds a list of all discovered (and not timed out) remote UEs that support relay UEs, a list of all remote UEs that have an active PC5 connection with the relay UE and additional data from the remote UE configuration and capabilities.

In embodiments, the list of remote UEs (from the relay point of view, target UEs) can include at least one out of the following information per remote UE:
supported application IDs,
active group IDs,
RSSI readings,
L2 IDs (see [6]—e.g. source/destination L2 ID),
UE type (e.g., bike, car, pedestrian, industrial machine),
UE velocity or mobility indicator,
UE position (relative or absolute).

If the relay UE receives a discovery message model B (“who is there”), the relay UE can-instead of forwarding the message-directly answer with a list of remote UEs that are possible target UEs for the source UE discovery.

In case a remote UE in the list is already ‘gone’, the resolution is captured by PC5 RLF between source and target UE.

Because the source UE knows about the relay, the relay could also inform the source UE about the RLF between relay UE and target UE.

A relay may include information which facilitates the relay selection, such as one or more out of:
remaining battery level of the relay or indication of a low-battery-status,
relay DRX configuration,
number of connected UEs,
list of remote UEs (e.g., in case of multi-hop operation, for each UE the list may include hop count and maximum hop count),
list of source UEs (e.g., in case of multi-hop operation, for each UE the list may include hop count and maximum hop count),
list of supported application of service IDs,
list of supported groups, or an special indication to say all groups are supported,
list of supported PLMNs and/or SNPNs.

Such relay information can be sent by the relay on discovery message if the relay is initiating the discovery procedure (Embodiment 1.3: Relay UE initiates discovery procedure) or need to send discovery messages in general, for example to forward discovery information from the source UE to the target UE. In case other nodes initiate the discovery procedure (Embodiment 1.2: Source UE initiates discovery procedure (out-of-coverage scenario) and Embodiment 2.1: Selection Criteria for SL Relay), the relay information may be sent in the response to the discovery message. The discovery message could also send out as a broadcast message with additional information to keep the original discovery message compact.

### 2.3 Embodiment 2—(Re-)Selection

### 2.3.1 Embodiment 2.1: Selection Criteria for SL Relay

In embodiments, discovery can be initiated by one out of:
source UE,
target UE,
relay UE,
gNodeB (trigger discovery).

In embodiments, the decision which relay to use is taken by the source UE, the target UE or the gNodeB. However, the relay may veto the decision based on security parameters, network policy or internal settings (for example, the relay UE could deny a relay connection in case of the following: low battery, too many UEs, blocklisted devices (UEs on blocklist because of ‘bad’ behavior, etc. This is a local setting of the relay UE. There is no signaling yet for battery status to gNodeB regarding SL relay). A denied request may be already signaled by the relay during the discovery phase or during a later phase. The relay UE can inform the gNodeB about the decision and may ‘deregister’ as a relay node.

Internal settings could be one or more out of:
blocklist for blocked UEs,
settings from higher layer,
no support for application ID (app id is known to increase load and relay is not willing to do that),
battery status,
load (similar to selection criterion).

In general all criteria/events for selection could also lead to the relay UE not being able/willing to act as a relay UE, even when assigned by the gNodeB. Further handling of this case would be needed.

The parameters/information/events considered for (re) selection criteria can be at least one out of
RSRP Threshold(s), e.g. a minimum and maximum RSRP threshold,
   threshold(s) may apply to both radio links: source UE-relay UE and/or target UE-relay UE, both kind of thresholds may be set individually or commonly for both;
load, e.g. relay UE load (to avoid overload of the relay UE),
   a threshold could be defined, e.g. for the upper bound of the load of the relay UE.
   the load could be based on the number of connected remote UEs, the processing power needed to handle the connections or a resource indicator,
   also internal system parameters available to the modem could be used, e.g. free memory, (chip) temperature, power consumption, etc;
number of remote UEs connected to this relay UE;
supported data rate of the relay UE;
UE capabilities (e.g. energy saving, coverage enhancements, etc.);
relay UEs: max. number of source and/or target UEs or UE-to-UE relay links to be supported;
by higher layer;
RRC message;
RLF (for re-selection).

These criteria can also be used for (Re-)Selection of a relay.

### 2.3.2 Embodiment 2.2: Relay Re-Selection

In embodiments, when a remote UE has selected a U2U relay UE, there are reasons to select another relay. The termination and re-selection of a new relay can be initiated by:
the source UE,
the target UE,
the relay UE, and/or
the gNodeB (trigger discovery) (e.g., applicable in in-coverage or partial-coverage scenarios).

In embodiments, a connected remote UE wants to select a new relay based on channel quality or other measurements or indicators and performs SL Relay Discovery. It then prepares selection of a suitable new U2U relay (because currently, only a single relay can be connected).

In embodiments, the Remote UE tells the current relay UE and/or the base station (e.g., gNode B (in-coverage case)) that it will do a re-selection and connect to a different relay UE with a certain ID.

In embodiments, the relay UE takes this information into account and informs this UE and/or the base station (e.g., gNodeB) about the reselection. This information can be independent of further messages from the re-selecting remote UE to the other remote UE, but can also be tied to a specific (last) message sent.

In embodiments, a (connected) remote UE (e.g. a target UE) informs the relay UE and/or base station (e.g., gNodeB) that it is choosing a new relay UE, so the relay UE can indicate this to other remote UEs (e.g. source UEs) that are trying to contact the remote UE so they can handover/select/discover the same new relay UE or try to discover the remote UE directly.

In embodiments, this “relay UE modification” information may include e.g. a time stamp and the ID of the new relay UE, so that the target and source UE can change to the new relay UE at the same point in time.

In embodiments, the same procedure may be applicable for the source UE.

In embodiments, the relay UE may send e.g. measurement reports e.g. using “assistance information” or any other format to inform the source and target UEs on the e.g. signal strength/quality. Based on thresholds (e.g., usually thresholds can be min and max thresholds), the source and/or target UE may initiate a relay UE change procedure.

In embodiments, reasons for re-selection of a relay can be at least one or more of the following:
RSRP below or above a threshold (min/max),
insufficient QOS parameters, e.g.:
   high transmission/packet/forward delay,
   fragmented packets,
   low data-rate,
   limited,
load of the relay node (e.g. number of connected UEs, data-rate, processing, low memory),
indication of (low) battery status,
indicated by higher layers,
relay UE wants to stop relay service, based on other events.

In embodiments, a relay UE might want to stop to provide a relay service, because it needs a higher service quality for its own application, e.g. V2X fleet control. This could also be triggered by higher layer, e.g. an application that needs a lot of processing power, low delay or other QoS features. The relay UE might as well stop the service if it moves from IC to OOC because it is not able to do coordination on its own. This could be because of missing capabilities, limited processing power and memory, limited measurement capabilities or any other property of the UE.

In embodiments, in an in-coverage scenario all information about relay termination, reselection and timing can be shared with the base station (e.g., gNodeB) to enable proper control of resources and selection criteria, to assist remote UEs with discovery/selection and/or schedule resources accordingly.

### 2.3.3 Embodiment 2.3: Relay Triggered Termination and Re-Discovery

In embodiments, a UE-to-UE relay may have urgent reasons to terminate its operation as relay, for example:
critical battery level,
reinitiation of operating system,
hardware failure, and/or
reconfiguration (disabling relay operation).

In embodiments, in case the UE-to-UE relay needs to finalize its relay operation it should send a message to the source and target UEs which are using such relay. This message may be broadcast, groupcast or unicast.

In embodiments, the message may indicate an imminent termination and may include how long the relay operation will still be possible. An immediate termination (Oms remaining) may also be indicated.

In embodiments, when a source UE or target UE receives a relay termination message they may start the discovery procedure again or use previously acquired information to perform a re-selection. A special code may be sent to the new relay to indicate that the affected UEs are trying to re-establish a previously operating connection.

### 2.4 Further Embodiments

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 18 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LIST OF REFERENCES

[1] TR 23.752 v17.0.0—Study on system enhancement for Proximity based Services in 5G System
[2] TR 38.836 v17.0.0—Study on Sidelink Relay Rel-17
[3] TS 23.303 v17.0.0—Proximity-based services (ProSe)
[4] TS 38.300 v17.0.0—NR Overall Description-Discovery
[5] TS 23.287 v17.3.0—Architecture enhancements for 5G System (5GS) to support Vehicle-to-Everything (V2X) servicesV2X Architecture
[6] TS 38.331 v17.1.0—NR; Radio Resource Control (RRC); Protocol specification

### Abbreviations

3GPP third generation partnership project
ACK acknowledgement
AIM assistance information message
AMF access and mobility management function
BS base station
BWP bandwidth part
CA carrier aggregation
CC component carrier
CBG code block group
CBR channel busy ratio
CQI channel quality indicator
CSI-RS channel state information-reference signal
CN core network
D2D device-to-device
DAI downlink assignment index
DCI downlink control information
DL downlink
DRX discontinuous reception
FFT fast Fourier transform
FR1 frequency range one
FR2 frequency range two
GMLC gateway mobile location center
gNB evolved node B (NR base station)/next generation node B base station
GSCN global synchronization channel number
HARQ hybrid automatic repeat request
IC in-coverage
ICS initial cell search
IoT internet of things
LCS location services
LMF location management function
LPP LTE positioning protocol
LTE long-term evolution
MAC medium access control
MCR minimum communication range
MCS modulation and coding scheme
MIB master information block
NACK negative acknowledgement
NB node B
NES network energy saving
NR new radio
NTN non-terrestrial network
NW network
OFDM orthogonal frequency-division multiplexing
OFDMA orthogonal frequency-division multiple access
OOC out of coverage
PBCH physical broadcast channel
P-UE pedestrian UE; not limited to pedestrian UE, but represents any UE with a need to save power, e.g., electrical cars, cyclists,
PC5 interface using the sidelink channel for D2D communication
PDCCH physical downlink control channel
PDSCH physical downlink shared channel
PLMN public land mobile network
PPP point-to-point protocol
PPP precise point positioning
PRACH physical random access channel
PRB physical resource block
ProSe proximity service
PSFCH physical sidelink feedback channel
PSCCH physical sidelink control channel
PSSCH physical sidelink shared channel
PUCCH physical uplink control channel
PUSCH physical uplink shared channel
RAIM receiver autonomous integrity monitoring
RAN radio access networks
RAT radio access technology
RB resource block
RNTI radio network temporary identifier
RP resource pool
RRC radio resource control
RS reference symbols/signal
RTT round trip time
SBI service based interface
SCI sidelink control information
SI system information
SIB sidelink information block
SL sidelink
SPI system presence indicator
SSB synchronization signal block
SSR state space representations
TB transport block
TT short transmission time interval
TDD time division duplex
TDOA time difference of arrival
TIR target integrity risk
TRP transmission reception point
TTA time-to-alert
TTI transmission time interval
U2N UE to network
U2U UE to UE
UCI uplink control information
UE user equipment, e.g., a smartphone or IoT node
UL uplink
UMTS universal mobile telecommunication system
V2x vehicle-to-everything
V2V vehicle-to-vehicle
V21 vehicle-to-infrastructure
V2P vehicle-to-pedestrian
V2N vehicle-to-network
V-UE vehicular UE
VRU vulnerable road user
WUS wake-up signal

1. UE of a wireless communication system,
wherein the UE is configured to operate in a sidelink mode of operation,
wherein the UE is configured, for establishing a connection with a target UE or a group of target UEs via a UE-to-UE relay, to transmit a discovery message for discovering one or more candidate relay UEs that are connected or able to connect to the target UE or group of target UEs,
wherein the UE is configured to select another relay UE for communicating with the target UE or group of target UEs if a reselection criterion is fulfilled and/or in response to a reception of a reselection control message,
wherein the reselection criterion is at least one out of
a signal strength of a link between the UE and the relay UE,
a signal strength of a link between the relay UE and the remote UE,
an information received from a higher layer.

2.-9. (canceled)

10. UE as claimed in claim 1,
wherein the UE is configured, when the reselection criterion is fulfilled or in response to the reception of the reselection control message, to select the other relay out of the one or more candidate relay UEs.

11. UE as claimed in claim 1,
wherein the UE is configured, when the reselection criterion is fulfilled or in response to the reception of the reselection control message, to transmit a further discovery message for discovering one or more candidate relay UEs that are connected or able to connect to the target UE or group of target UEs,
wherein the UE is configured to receive a further discovery response message from one or more candidate relay UEs that are connected or able to connect to the target UE or group of target UEs,
wherein the UE is configured to select the other relay UE out of the one or more candidate relay UEs.

12. UE as claimed in claim 1,
wherein the UE is configured to transmit a reselection information message to the relay UE, the reselection information message informing the relay UE for handover to the other relay UE about the selected other relay UE,
or wherein the UE is configured to transmit a reselection information message to a base station, the reselection information message informing the base station about the selected other relay UE and requesting the base station to coordinate the handover to the selected other UE.

13. (canceled)

14. Relay UE of a wireless communication system,
wherein the relay UE is configured to operate in a sidelink mode of operation,
wherein the relay UE is configured to receive a discovery message from a source UE, the discovery message indicating a target UE or a group of target UEs to which the source UE requests a relaying of messages,
wherein the relay UE is configured, in case the relay UE is able to relay messages between the source UE and the target UE or group of target UEs, to transmit a discovery message response to the source UE, the discovery message response indicating that the relay UE is able to relay messages between the source UE and the target UE or group of target UEs,
wherein the relay UE is configured, upon receiving a reselection information message from one out of the source UE, target UE and base station, the reselection information message informing the relay UE about a handover to another relay UE, to transmit a further reselection information message to the other one out of the source UE, target UE and base station, the further reselection information message informing about the selected other relay UE.

15.-28. (canceled)

29. Relay UE as claimed in claim 14,
wherein the relay UE is configured to handover the traffic between the source UE and the target UE to the other relay UE at a time indicated in the reselection information message.

30. Relay UE as claimed in claim 14,
wherein the relay UE is configured to transmit a relay reselection control message to the source UE and/or target UE and/or base station in case that a relay reselection criterion is fulfilled, the relay reselection control message controlling the source UE and/or target UE and/or base station to select another relay UE.

31. Relay UE as claimed in claim 30,
wherein the relay reselection criteria is at least one out of
a signal strength of a link between the UE and the relay UE,
a signal strength of a link between the relay UE and the remote UE,
one or more QoS parameters,
a load of the relay UE,
a battery status of the relay UE,
an information received from a higher layer,
an information or control message from the base station,
a relay operation termination criterion.

32. Relay UE as claimed in claim 14,
wherein the relay UE is configured to stop relaying in case that a relay operation termination criterion is reached.

33. Relay UE as claimed in claim 32,
wherein the relay UE is configured to transmit a control message to the source UE and/or target UE and/or base station indicating that the relay UE stops relaying in case that the relay operation termination criterion is reached.

34. Relay UE as claimed in claim 32,
wherein the relay operation termination criterion is one out of
a critical battery level of the relay UE,
a reinitiation of an operating system of the relay UE,
a hardware failure of the relay UE,
a reconfiguration of the relay UE,
one or more QoS parameters,
a load of the relay UE,
a battery status of the relay UE,
an information received from a higher layer,
an information or control message from the base station,
a relay operation termination criterion.

35. Target UE of a wireless communication system,
wherein the target UE is configured to operate in a sidelink mode of operation,
wherein the target UE is configured to communicate with a source UE of the wireless communication network via a relay UE of the wireless communication network,
wherein the target UE is configured
to reselect another relay UE
or to transmit a relay reselection control message to the source UE, the relay reselection control message controlling the source UE and/or the base station to select another relaying UE
when a reselection criterion is fulfilled.

36. Target UE as claimed in claim 35,
wherein the reselection criterion is at least one out of
a signal strength of a link between the UE and the relay UE,
a signal strength of a link between the relay UE and the remote UE,
one or more QoS parameters,
a load of the relay UE,
a battery status of the relay UE,
an information received from a higher layer,
a control message received from the relay UE indicating that the relay UE stops relay operation.

37. Target UE as claimed in claim 35,
wherein the target UE is configured to reselect another relay by transmitting a discovery message for discovering one or more candidate relay UEs that are connected or able to connect to the source UE,
wherein the target UE is configured to select the other relay UE out of the one or more candidate relay UEs that are connected or able to connect to the source UE.

38. Target UE as claimed in claim 37,
wherein the target UE is configured to reselect the other relay UE out of the one more candidate relay UEs in dependence on a selection criterion.

39. Target UE as claimed in claim 37,
wherein the target UE is configured to transmit a reselection information message to the relay UE, the reselection information message informing the relay UE for handover to the other relay UE about the selected other relay UE,
or wherein the target UE is configured to transmit a reselection information message to a base station, the reselection information message informing the base station about the selected other relay UE and requesting the base station to coordinate the handover to the selected other UE.

40.-44. (canceled)
